(19) United States
(12) Patent Application Publication
(10) Pub. No.: US 2003/0098558 A1
(43) Pub. Date: May 29, 2003

(54) Sports device, preferably a snow or water vehicle

(76) Inventors: Josef Steiner, Zug (CH); Adrian Bernet, Zurich (CH)

Correspondence Address: WENDEROTH, LIND & PONACK, L.L.P., 2033 K STREET N. W., SUITE 800, WASHINGTON, DC, 20006-1021, US

(21) Appl. No.: 10/181,806

(22) PCT Filed: Dec. 27, 2000
(86) PCT No.: PCT/CH00/00689

(51) Int. Cl. B62D 57/00

(52) U.S. Cl. 280/28.5

(57) ABSTRACT

A sports device (10), preferably a snow or water vehicle, has an outer shell (15) which when inflated, forms a support surface (13) underneath and a lying down or sitting surface (20) on top. An inflatable tubular shell (20) with two segments (21, 22) extending crosswise across it is provided in this outer shell (15). The outer shell (15) consists of a robust fabric which is coated or laminated with plastic. The tubular shell (20), which is in itself separate from the outer shell, is produced from plastic films, preferably without any fabric reinforcement. The outer shell may also be connected to the tubular shell in such a way that they form a single film. The inventive sports device can therefore be produced with optimal materials for the outer shell or the tubular shell, with the result that it has a long service life.

The invention relates to a sports device, preferably a snow or water vehicle, which can be inflated with a medium, especially air, and which comprises an outer shell, which when inflated forms a support surface underneath and a lying or sitting surface on top.

A generic sports device according to the document DE-A-34 34 384, which relates to an air-cushion toboggan, provides four longitudinal rolls arranged side by side, which can be inflated with air. The rolls at the two outer sides are parallel to one another at the rear end and arranged conically at the front, tapering inwards towards a point, while the two inner rolls extend in the longitudinal direction of the toboggan, and, in this context, serve as the sitting area of the toboggan. The outer rolls are each fitted with guide runners underneath, which taper at the front towards a point. Furthermore, handles, which the driver can hold during travel, are fitted to the upper side of the outer rolls.

One problem with this toboggan relates to its manufacture wherein it is necessary to ensure that the rolls are manufactured from a sufficiently rigid material. Because, if the toboggan were to travel over an object, for example a protruding, pointed stone, a hole could quickly appear in the shell affected and the air pressure provided would immediately decline. Accordingly, the toboggan could only been driven with difficulty or not at all. A further disadvantage is that during travel, the driver must displace his weight to the outer side of the toboggan in order to make a curve. Because of the centrifugal force acting on the driver when travelling in a curve, there is a risk that he may fall sideways from the toboggan.

The present invention is therefore based upon the object of creating a sports device of the type mentioned in the introduction, which is constructed with increased safety and corresponding strength with the purpose of providing a longer service life. Furthermore, the present sports device should provide improved steering capability.

This object is achieved according to the invention in that an inflatable tubular shell is integrated inside the outer shell, which is either at least partially separate or connected to the outer shell, and that at least one connecting segment extending crosswise through it is provided, which connects the lower support surface to the lying or sitting surface located above it.

By providing the outer shell and the tubular shell contained inside it, the sports device according to the present invention creates the substantial advantage that the outer shell can be made from a material, which is very resistant to contact with solid objects and to frictional wear, and furthermore, as an advantage in manufacturing, can be fitted without difficulty with accessory components such as runners, handles, eyelets etc.

By contrast, the inner tubular shell, which advantageously forms a single film together with the outer shell, can be fitted with a material specific for its purpose. Accordingly, this device can also be fitted with runners to allow very simple and effective steering.

In one very advantageous embodiment, the outer shell and tubular shell, manufactured in each case from an upper and a lower film layer, are welded together around the lateral perimeter by means of a continuous seam, whereby the outer shell comprises a robust fabric, which is coated or laminated with a synthetic material, while the tubular shell comprises a synthetic film. Accordingly, optimum conditions are provided for a safe sports device with a long service life.

Further embodiments of the invention and additional advantages will be presented below with reference to the diagrams. The diagrams are as follows:

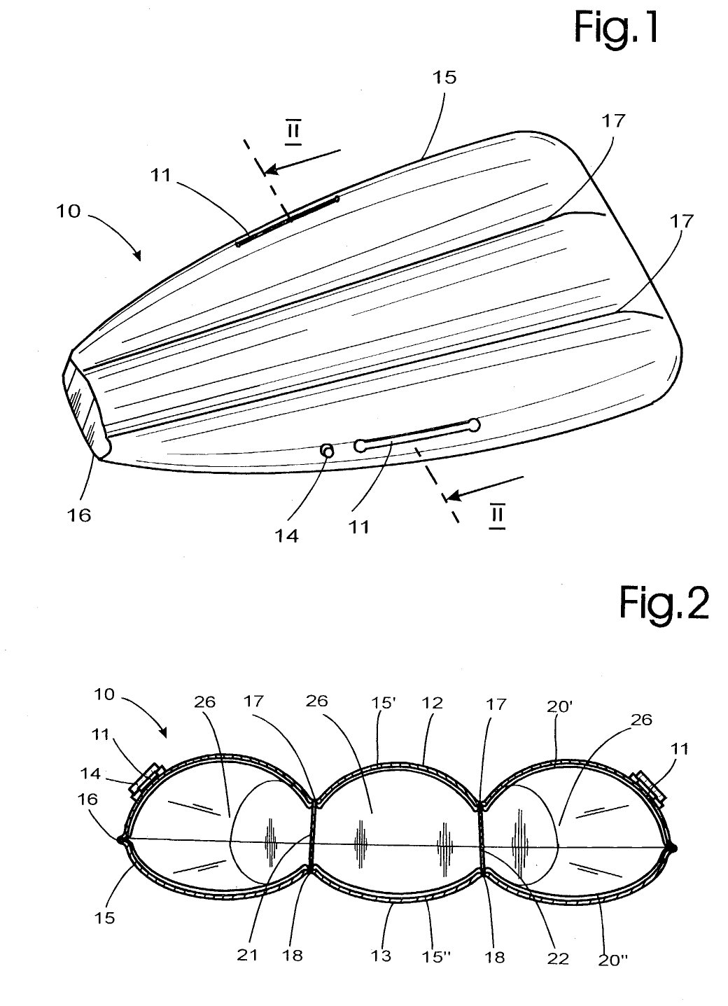

FIG. 1 Perspective view of a sports device according to the invention;

FIG. 2 Cross-section through the sports device according to FIG. 1 along the line II-II;

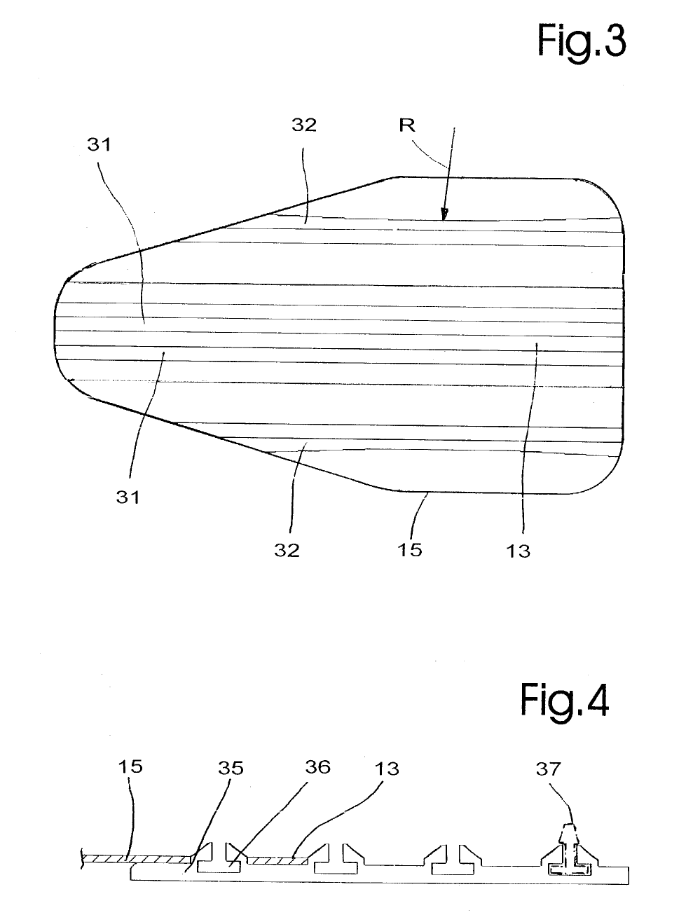

FIG. 3 View of the sports device according to FIG. 1 from below;

FIG. 4 Partial cross-section of the outer shell with support surface and attachable runners as a design variant;

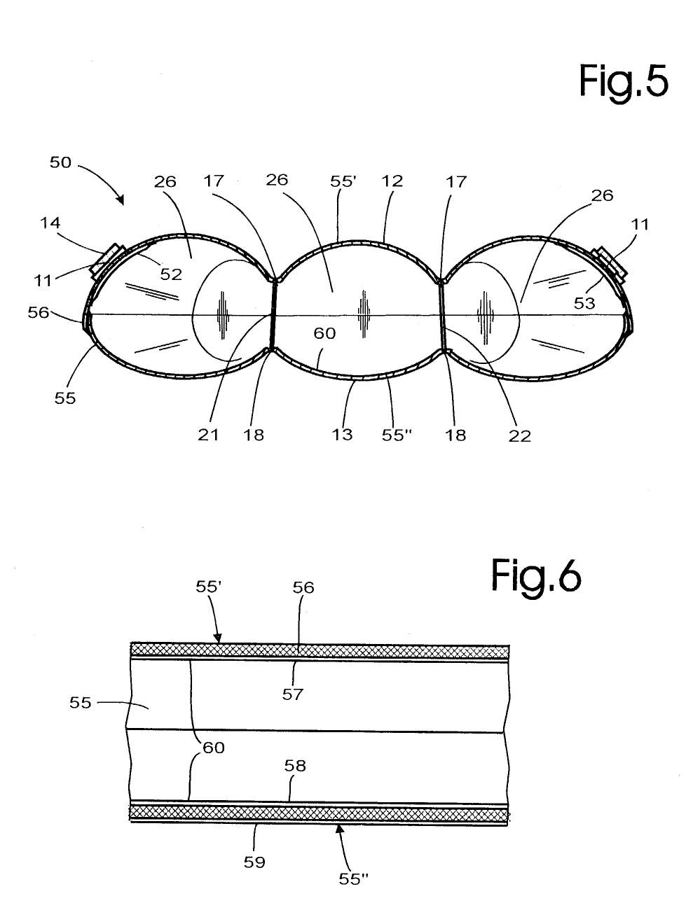

FIG. 5 Cross-section through a sports device in a design variant in which the outer shell and the tubular shell consist of a single film;

FIG. 6 Partial longitudinal section through the sports device according to FIG. 5.

FIG. 1 shows a sports device 10, which, in the present embodiment, is especially designed as a toboggan, but could essentially be used as any desired snow vehicle or water vehicle. This sports device 10 is inflated with a medium, especially air, and comprises an outer shell 15, which when inflated forms a support surface 13 underneath and a lying or sitting surface 12 on top.

In FIG. 2, an inflatable tubular shell 20 is provided according to the invention with two connecting segments 21, 22 extending crosswise through it, which connect the lower support surface 13 to the lying or sitting surface 12 of the outer shell 15 in order to limit the spacing and provide shape to the outer shell.

The outer shell 15 and the tubular shell 20 are each manufactured from two correspondingly dimensioned pairs of film 15′, 20′; 15″, 20″, one of which forms the upper side and the other the lower side of the device 10. The two-part tubular shell 20, with its film layers 20′, 20″, is of approximately the same dimensions as the associated film layers 15′, 15″ of the outer shell 15. These superimposed film pairs 15′, 20′; 15″, 20″ are welded together at the lateral perimeter by means of a continuous seam 16, so that an enclosed chamber is formed inside the tubular shell 20.

The outer shell 15 is made from a robust fabric, which is coated or laminated with an appropriate synthetic material, and the tubular shell 20, which is per se separate from the latter is made from at least one synthetic-material film. The upper film 15′ of the outer shell 15 comprises a rough outer surface, so that a person seated on it will not slip. The inside of this film 15′ is coated or laminated with a synthetic material, so that it can be welded together with the per se separate tubular shell 20 and the lower film.

The lower film 15″ is also manufactured from a robust fabric, which is coated or laminated on both sides with a synthetic material. The inside of the lower film is preferably coated or laminated with the same synthetic material as the inside of the upper film 15′. The lower side of the lower film 15″ is coated or laminated with a synthetic material providing very good gliding properties, so that the sports device glides well on snow or water.

In one very advantageous embodiment, the upper film 15′ of the outer shell 15 comprises a Gore-Tex Cordura fabric coated with polyurethane TPU and/or a nylon fabric, while the lower film 15″, 55″ is manufactured from a robust Kevlar, Teflon or nylon fabric, whereby the insides of both films are coated or laminated with polyurethane TPU. The outer side of the upper film which forms the sitting surface is uncoated, while the outer side of the lower film 15″, 55″ which forms the gliding surface, is coated or laminated with a PVC or TPU synthetic material provided with good gliding properties. The tubular shell 20 is manufactured from polyurethane TPU preferably without additional fabric. This combination of materials provides, in particular, the advantage that the two different shells can be very readily welded together. Of course, other materials which fulfil the required properties for this sports device 10, may in principle also be used.

Within the context of the invention, two connecting segments 21, 22 running approximately symmetrical to the longitudinal central axis of the outer shell 15 are provided. Each of these connecting segments 21, 22, which are also manufactured from a synthetic material corresponding to the fabric coating, is welded together to the support surface 30 underneath and to the seating surface 12 on top of the outer shell 15 and the tubular shell 20, in each case forming a longitudinal seam 17, 18, thereby creating one longitudinal roll in the centre and one at each outer side. In accordance with FIG. 1, a continuous longitudinal seam 17, 18 results in a uniform, straight dividing line between the rolls.

These connecting segments 21, 22 are formed approximately along the entire length of the outer shell 15. However, a connection between the individual chambers 26 is provided at the front and the back, so that only one valve 14 is required for inflation and deflation with air. This provides the further advantage that when the driver shifts his weight, the air can escape into the unloaded chambers. In principle, however, the three chambers 26 could be separated from one another, and a separate valve 14 could be allocated to each one.

When welding together the film layers 15′, 15″; 20′, 20″ and the connecting segments 21, 22, the connections through the longitudinal seams 17, 18 are produced first; and the seam 16 at the outer perimeter is only produced after this, advantageously by means of a per se familiar high-frequency electrical welding technique.

When inflated, the outer shell 15 forms a mattress shape, as shown in FIG. 1, and in this context tapers laterally towards the front. Moreover, a handle 11 is attached at each side. This provides the further advantage that, any accessory components such as handles 11, eyelets, pockets and similar can be attached to this outer shell 15, without the occurrence of problems relating to sealing, because the tubular shell is separate from these accessory components. Only the valve 14 extends through the outer shell into the tubular interior.

The materials for the outer shell 15, the tubular shell 20 and connecting segments 21, 22 are designed to be flexible so that the device 10 can readily be folded and stored, for example, in a rucksack.

FIG. 3 shows the sports device 10 from below, illustrating its runners 31, 32 arranged in the longitudinal direction, and attached to the support surface 13 of the outer shell 15. The two outer runners 32 are not straight, but are curved outwards with a radius R. Accordingly, the driver can shift his weight to the inner side of the toboggan thereby producing increased pressure on one of these two runners 32. This slightly tapering design of the runners 32 allows the toboggan to produce curves as it were automatically when the weight is shifted to one or the other of these runners. The radius R is preferably in the order of magnitude between 5 and 20 metres.

In accordance with FIG. 4, as a design variant, a profiled plate 35 with several T-grooves 36 arranged adjacently for retaining the runners 37 is welded onto the support surface 13 of the outer shell 15. This illustrates that with the design of the device according to the invention, various solutions can be implemented depending on requirements.

FIG. 5 shows a sports device 50, which is essentially constructed in the same manner as that shown in FIG. 1. For this reason, the same reference characters are used to refer to the same components. By contrast with the design according to FIG. 1, an outer shell 55 and a tubular shell 60 are provided; these are connected to one another and form a single film. Again, an upper and a lower film are provided, which are welded together laterally by means of an overlap 56.

In accordance with FIG. 6, the outer shell 55 is manufactured from a robust fabric, which, again, is coated or laminated with synthetic material. For this purpose, the upper film 55′ comprises a rough outer surface with the robust fabric 56. On the inside 57, it is coated or laminated with synthetic material and thereby forms the tubular shell. The lower film 55″ is also made from the robust fabric 56, moreover, coated or laminated on the inside 58 with synthetic material to form the tubular shell, and provided with the appropriate, synthetic material offering good gliding properties on the outside 59 to form the gliding surface.

Moreover, in the case of this sports device 50, it is advantageous for a separate piece of film 52, 53 to be attached, especially welded, in each case to the inside of the tubular shell 60 at all positions, at which accessory components, such as runners, handles 11, eyelets or the valve are attached to the outer shell 55, so that an additional seal is provided at these positions.

This sports device is preferably used as a toboggan, which can be steered very easily and is also suitable for deep snow.

With reference to the exemplary embodiments described above, the invention has been adequately explained. However, it could be presented in still further variants. In principle the tubular shell could also be manufactured completely separately from the outer shell and inserted into the latter and advantageously attached to it.

Furthermore, only one or more than two crosswise-extending connecting segments could be provided inside the tubular shell 20.

The outer shell and also the tubular shell could in each case comprise a sock-shaped shell only being connected together at the front and the rear. Also, their outer shape could, of course, be designed differently from the examples presented, for instance, being rounded, oval, elliptical or similar.

1. Sports device, preferably a snow or water vehicle, which can be inflated with a medium, in particular air, which comprises an outer shell (15), which when inflated forms a support surface (13) underneath and a lying or sitting surface (12) on top, characterised in that an inflatable tubular shell (20, 60) is integrated inside the outer shell (15, 55), which is either at least partially separate or connected to the outer shell (55); and at least one connecting segment (21, 22) extending crosswise through it and connecting the lower support surface (13) to the lying or sitting surface (12) located above is provided.

2. Sports device according to claim 1, characterised in that the outer shell (55) is made from a robust fabric (56), which is coated or laminated with an appropriate synthetic material, and the tubular shell (60) connected to its inside (57, 58), is made from at least one synthetic material film without fabric reinforcement.

3. Sports device according to claim 2, characterised in that a separate piece of film (52, 53) is attached, in particular welded to the inside of the tubular shell (60), in each case, at those positions at which accessory components, such as runners, handles (11), eyelets or valves (14) are attached to the outer shell (55), so that an additional seal is provided at these positions.

4. Sports device according to claim 1, characterised in that the outer shell (15) is manufactured from a robust fabric, which is coated or laminated with an appropriate synthetic material, and the tubular shell (20), which is separate from the latter, is made from at least one synthetic material film preferably without fabric reinforcement.

5. Sports device according to claim 4, characterised in that the outer shell (15) and the tubular shell (20) are each manufactured from 2 appropriately dimensioned film layers (15′, 15″; 20′, 20″), the outer edges of which run along the seam (16).

6. Sports device according to any one of the preceding claims 1 to 5, characterised in that the film (15′, 55′) located on the upper side of the outer shell (15, 55) comprises a rough surface, while the film (15″, 55″) located on the underside comprises a surface with good gliding properties.

7. Sports device according to claim 6, characterised in that the upper film (15′, 55′) of the outer shell (15, 55) is made from a polyurethane (TPU)-coated Gore-Tex Cordura fabric [??] and/or from a nylon fabric, while the lower film (15″, 55″) is made from a robust Kevlar, Teflon or nylon fabric, wherein the insides of both films are coated or laminated with polyurethane (TPU), and that the outside of the upper film which forms the sitting surface is uncoated, while the outside of the lower film (15″, 55″) which forms the sliding surface is coated or laminated with a PVC or TPU synthetic material providing good gliding properties.

8. Sports device according to any one the preceding claims 1 to 7, characterised in that at least one connecting segment (21, 22) made from a synthetic material is welded in each case at the bottom to the support surface (13) and at the top to the sitting surface (12) of the outer shell (15) and the tubular shell (20) forming a longitudinal seam (17, 18) in each case.

9. Sports device according to any one of the preceding claims 1 to 8, characterised in that the outer shell (15, 55) and the tubular shell (20, 60) are welded to one another at the lateral perimeter by means of a continuous seam (16) comprising a butt-seam or overlapping seam.

10. Sports device according to any one of the preceding claims 1 to 9, characterised in that two connecting segments (21, 22) running approximately symmetrical to the longitudinal central axis of the outer shell (15, 55) are provided, thereby creating a longitudinal roll in the centre and at each of the outer sides.

11. Sports device according to claim 10, characterised in that the connecting segments (21, 22) are formed approximately along the entire length of the outer shell (15), but, that a connection is provided between the individual chambers (26) at least at the front or at the rear.

12. Sports device according to any one of the preceding claims 4 to 11, characterised in that the accessory components, such as runners, handles (11), eyelets or similar can be attached exclusively to the outer shell (15), while the valve (14) extends through the latter into the interior of the tubular shell (20).

13. Sports device according to any one of the preceding claims 1 to 12, characterised in that the outer shell (15) forms a mattress shape when inflated and, in this context, tapers laterally towards the front, but may also comprise a rounded, oval, elliptical a similar exterior shape.

14. Sports device according to any one of the preceding claims 1 to 13, characterised in that the materials provided for the outer shell (15), the tubular shell (20) and the connecting segments (21, 22) are such that the device (10) can be folded and stored, for example, in a rucksack.

15. Sports device according to any one of the preceding claims 1 to 14, characterised in that a profiled plate (35) for retaining runners (37) is welded on to the support surface (13) of the outer shell (15).
